(19) United States
(12) Patent Application Publication
(10) Pub. No.: US 2017/0317901 A1
(43) Pub. Date: Nov. 2, 2017

(54) INTEGRATED APPROACH TO MONITOR GBP HEALTH AND ADJUST POLICY SERVICE LEVEL

(71) Applicant: Cisco Technology, Inc., San Jose, CA (US)

(72) Inventors: Sanjay Agrawal, San Jose, CA (US); Ruchir Gupta, Fremont, CA (US); Syed Basheeruddin Ahmed, Santa Clara, CA (US); Yi Yang, Cary, NC (US); Wojciech Dec, Amsterdam (NL)

(21) Appl. No.: 15/142,308

(22) Filed: Apr. 29, 2016

(51) Int. Cl. H04L 12/26; H04L 12/24

(52) U.S. Cl. CPC H04L 43/08; H04L 41/0893; H04L 43/16

(57) ABSTRACT

Disclosed are systems, methods, and computer-readable medium for adjusting group based policies. A controller in a network can gather operational data describing performance of an end point group (EPG) in the network. The EPG can be operating according to a first set of policies to achieve a desired performance for the end point group. The controller can calculate a health score for the end point group based on the operational data. The health score can indicate whether an actual performance of the end point group is meeting the desired performance of the end point group. The controller can determine, based on the health score, that the actual performance of the end point group is not meeting the desired performance of the end point group, and apply a second set of policies to the end point group to achieve the desired performance of the end point group.

### TECHNICAL FIELD

This disclosure relates in general to the field of computer networks and, more particularly, pertains to policy management.

### BACKGROUND

Managing network resources in large scale networks can be challenging. The problem becomes more severe in a cloud environment utilizing group based policy (GBP). While GBP aims to address cloud complexity issues by offering a simple, abstract design to capture user intent, the underlying execution and operation still present challenges from the dynamic environment. For example, there could be multiple suites of policies for firewall service. The suites may be differentiated with different performance, service level and cost. Customers may choose a policy with a low service level to minimize their initial cost. However, as traffic increases, the firewall may not be able to handle the traffic, the policy is degraded, and user's intent is undermined. To deal with these challenges, we need an approach to monitor the health of policy, and adjust the GBP correspondingly.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates an example cloud network environment;

FIG. 2 shows an example controller configured to monitor performance of an End Point Group (EPG) and adjust policies to achieve a desired performance;

FIG. 3 shows an example method of monitoring performance of an EPG and adjusting policies to achieve a desired result; and

FIGS. 4A and 4B illustrate an example system embodiments according to some aspects of the subject technology;

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview:

Disclosed are systems, methods, and computer-readable storage media for adjusting group based policies applied to an end point group. A controller in a network can gather operational data describing performance of an end point group (EPG) in the network. The EPG can be operating according to a first set of policies to achieve a desired performance for the end point group. The controller can calculate a health score for the end point group based on the operational data. The health score can indicate whether an actual performance of the end point group is meeting the desired performance of the end point group. The controller can determine, based on the health score, that the actual performance of the end point group is not meeting the desired performance of the end point group, and apply a second set of policies to the end point group to achieve the desired performance of the end point group.

### DETAILED DESCRIPTION

A computer network is a geographically distributed collection of nodes interconnected by communication links and segments for transporting data between endpoints, such as personal computers and workstations. Many types of networks are available, with the types ranging from local area networks (LANs) and wide area networks (WANs) to overlay and software-defined networks, such as virtual extensible local area networks (VXLANs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by an intermediate network node, such as a router, to extend the effective “size” of each network.

Overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which virtual machines (VMs) communicate. The virtual segments can be identified through a virtual network identifier (VNI), such as a VXLAN network identifier, which can specifically identify an associated virtual segment or domain.

Network virtualization allows hardware and software resources to be combined in a virtual network. For example, network virtualization can allow multiple numbers of VMs to be attached to the physical network via respective virtual LANs (VLANs). The VMs can be grouped according to their respective VLAN, and can communicate with other VMs as well as other devices on the internal or external network.

Network segments, such as physical or virtual segments; networks; devices; ports; physical or logical links; and/or traffic in general can be grouped into a bridge or flood domain. A bridge domain or flood domain can represent a broadcast domain, such as an L2 broadcast domain. A bridge domain or flood domain can include a single subnet, but can also include multiple subnets. Moreover, a bridge domain can be associated with a bridge domain interface on a network device, such as a switch. A bridge domain interface can be a logical interface which supports traffic between an L2 bridged network and an L3 routed network. In addition, a bridge domain interface can support internet protocol (IP) termination, VPN termination, address resolution handling, MAC addressing, etc. Both bridge domains and bridge domain interfaces can be identified by a same index or identifier.

Furthermore, endpoint groups (EPGs) can be used in a network for mapping applications to the network. In particular, EPGs can use a grouping of application endpoints in a network to apply connectivity and policy to the group of applications. EPGs can act as a container for buckets or collections of applications, or application components, and tiers for implementing forwarding and policy logic. EPGs also allow separation of network policy, security, and forwarding from addressing by instead using logical application boundaries.

Cloud computing can also be provided in one or more networks to provide computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, and network devices, virtual machines (VMs), etc. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), databases, applications (Apps), etc.

Cloud computing resources may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. Cloud computing resources can also be provisioned via virtual networks in an overlay network, such as a VXLAN.

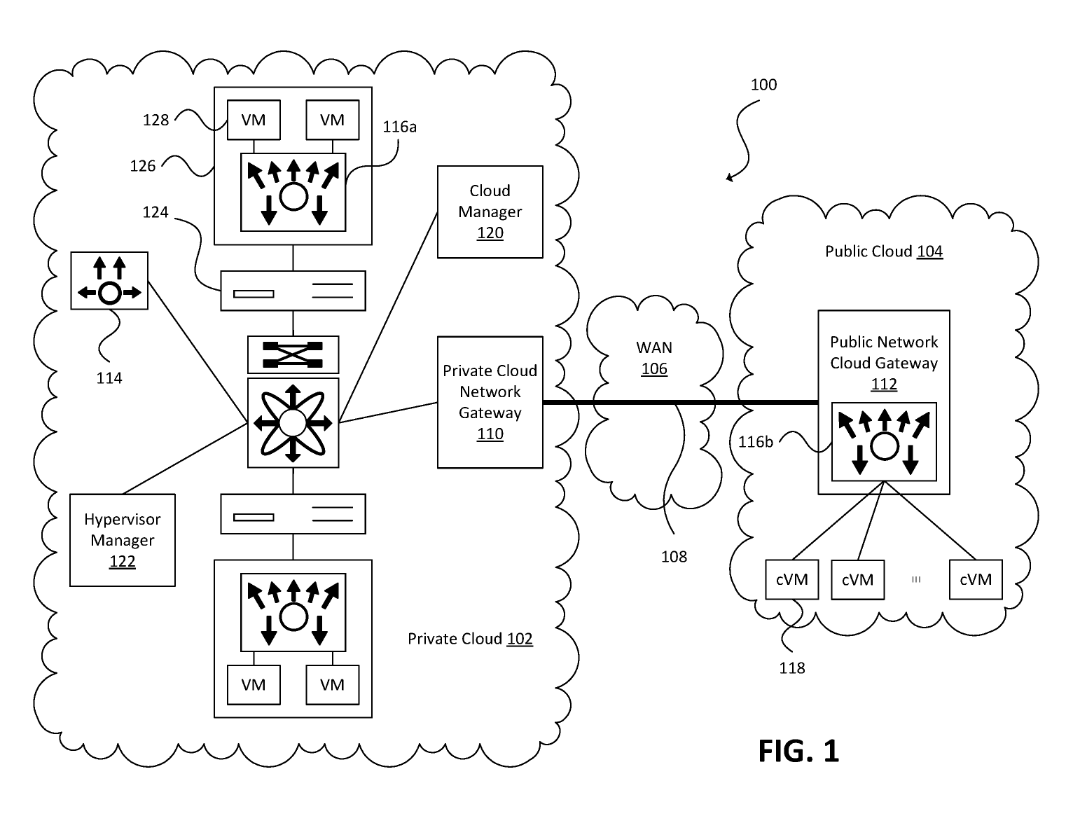

An example cloud network environment is illustrated in FIG. 1. The example cloud network environment can include a plurality of networks or clouds, such as the hybrid cloud network including a private cloud 102 (e.g., an enterprise virtual datacenter) and a public cloud 104 separated by a WAN 106, such as the Internet. Although a hybrid cloud is sometimes defined as consisting of a private cloud and a public cloud, it should be understood that many aspects of this disclosure can be practiced in various configurations (e.g., two or more public clouds hosted by third party cloud providers and/or two or more private clouds of an enterprise located in different locations). The private cloud 102 and the public cloud 104 can be integrated using overlay network techniques, such as VXLAN, NVGRE, NVO6, STT, or other overlay network protocols known to those of ordinary skill. The private cloud 102 and public cloud 104 can be connected via a site-to-site tunnel or communication link 108 between a private cloud network gateway 110 and a public cloud network gateway 112. The private cloud network gateway 110 can be configured as a VM for extending the private cloud across the Internet to the public cloud 104 through the site-to-site tunnel 108. The public cloud network gateway 112 can be configured as a VM switch overlay for interconnecting workloads running in the public cloud 104 via secure access tunnels, and for forwarding network traffic to the private network 102 using the site-to-site tunnel 108. In an example embodiment, the private cloud network gateway 110 can be implemented using Intercloud Fabric™ Extender (ICX) from Cisco®, Systems, Inc. of San Jose, Calif., the public cloud network gateway 112 can be implemented using Intercloud Fabric™ Switch (ICS) from Cisco®, and the ICX/ICS pair can form an Intercloud Fabric™ Cloud (ICFCloud).

In some embodiments, the private cloud network gateway 110 can establish, from the private cloud 102, the secure site-to-site tunnel 108 to interconnect with the public cloud network gateway 112, and interact with a virtual switch controller or Virtual Supervisor Module (VSM) 114. The VSM 114 can serve as a network controller for managing the network and security policies of the overlay network. In an example embodiment, the VSM 114 can be implemented in an active-standby model to ensure high availability, with a first VSM functioning in a primary role and a second VSM functioning in a secondary role. If the first VSM fails, the second VSM can take over control. A virtual chassis model can be used to represent VSM 114 and each virtual switch or Virtual Ethernet Module (VEM) under the VSM's control or within the VSM's domain, such as VEM 116a in the private cloud and public cloud VEM 116b. The high availability pair of VSMs 114 can be associated with slot numbers 1 and 2 in the virtual chassis, and the VEMs 116a and 116b can be sequentially assigned to the remaining slots. In the virtual chassis model, VSM 114 may be configured to provide control plane functionality for the virtual switches or VEMs 116a and 116b. The VEMs 116a and 116b can provide network connectivity and switching capability for VMs hosted on a corresponding server like a line card in a modular switching platform, and can operate as part of a data plane associated with the control plane of VSM 114. Unlike multiple line cards in a single chassis, each VEM can act as an independent switch from a forwarding perspective. In some example embodiments, the VEMs 116a and 116b may form a distributed virtual switch that can be controlled by the VSM 114. In an example embodiment, the VSM 114 and VEMs 116a and 116b can be implemented using Cisco Nexus® 1000V Series Switches.

The private cloud 102 can also include a hybrid cloud manager 120, which can be a management plane VM for auto-provisioning resources within the hybrid cloud network environment 100. The hybrid cloud manager 120 can be a management platform running in the private cloud 102, and may be responsible for providing hybrid cloud operations, translating between private cloud and public cloud interfaces, managing cloud resources, instantiating cloud gateways and cloud VMs though a private virtualization platform or hypervisor manager 122 and public cloud provider application programming interfaces (APIs). Hybrid cloud manager 120 may also monitor the health of all of the components of the network (e.g., cloud gateways, VMs, and communication links) and ensure high availability of those components.

In some embodiments, hybrid cloud manager 120 can be implemented as a virtual appliance, such as the Intercloud Fabric™ Director (ICFD) from Cisco®. The ICFD can be a hybrid cloud orchestration component that can provide a single point of management and consumption of hybrid cloud resources. That is, the ICFD can offer a single console so that users can provision workloads and associated policies. The ICFD can also expose northbound APIs, which allow users to programmatically manage their workloads in the hybrid cloud environment 100 or integrate with other cloud management platforms.

In some embodiments, a user can monitor and manage group-based policies (GBP) of a cloud environment by accessing cloud manager 120 on a mobile device. A group in a group-based policy (GBP) can represent a collection of network endpoints or endpoint groups (EPGs). A policy can include policy rules or contracts that define allowed communications between endpoints according to the groups that the endpoints belong to. For example, a policy may allow traffic between two endpoint groups. In another example, a policy may be to make a copy of data packets transmitted between two endpoint groups. As one that is skilled in the art will recognize, a policy is a flexible tool used to define numerous functions within a network. Other examples of policies include a redirect, a denial, a change in quality of service (QoS), an encryption, a drop, etc.

In some embodiments, policies can be applied in a bidirectional fashion. In other embodiments, policy parameters can be different for data going in one direction versus another direction.

The EPGs can be based on a number of different characteristics. For example, an endpoint group can be based on a subnet, an internet protocol (IP) address (e.g. destination IP or source IP), a virtual local area network (VLAN), a virtual extensible local area network (VXLAN), a media access control (MAC) address, a domain name server (DNS) name or range, network services, security services, network storage, access ports, etc. or any combination thereof. Those that are skilled in the art will recognize that EPGs are very flexible and can be defined based on any number of different factors. For instance, EPGs can be used to efficiently define policy within a network. By defining policies according to EPGs rather than individual endpoints, the scalability of the policy table can be greatly increased. As such, the GBP can describe a range of each traffic classifier between EPGs.

A set of policies can be applied to an EPG to achieve a desired performance or intent for the EPG. For example, if the desired performance or intent for the EPG is that load and or CPU rate not exceed a specified threshold, a set of policies can be applied to the EPG to achieve the desired performance or intent.

In some embodiments, sets of policies can be based on predetermined service levels. For example, each service level can provide varying levels of policies to ensure that an EPG performs at a desired performance level. In some embodiments, each higher service level can include one or more additional polices than included in the service level below. Alternatively, in some embodiments, each different service level can be associated with additional, fewer or even completely different sets of policies. An EPG can be assigned to a service level based on the desired performance of the EPG. Accordingly, the policies associated with the assigned service level will be applied to the EPG to ensure that the EPG meets the desired performance level.

In some embodiments, the network can be configured to monitor performance of an EPG to determine whether the EPG is performing at the desired performance level and adjust the service level if needed. For example, the network can include a controller configured to gather operational data describing performance of an EPG in the network. The controller can use the gathered operational data to calculate a health score for the EPG that indicates whether an actual performance of the EPG is meeting the desired performance of the EPG. If the controller determines that the actual performance of the EPG is not meeting the desired performance of the EPG, the controller can adjust the service level assigned to the EPG and apply additional policies associated with the service level to the EPG to achieve the desired performance of the EPG.

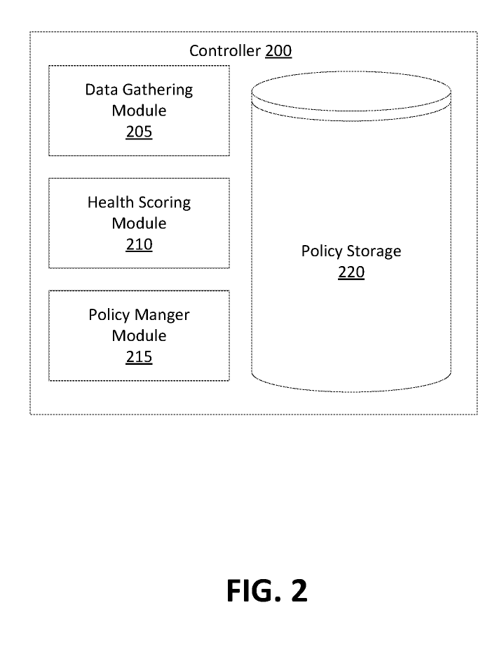

FIG. 2 shows an example controller configured to monitor performance of an EPG and adjust policies to achieve a desired performance. Controller 200 can be any type of device in a network, such as a switch, end point, etc. As shown, controller 200 can include data gathering module 205 that is configured to gather operational data from the network. Operational data can be any type of data that describes the performance of individual end points and/or an EPG. For example, operational data can include current load, errors, warnings, exceptions, central processing unit (CPU) rate, etc. Operational data can also including networking data such as bandwidth, throughput, delay, latency, jitter, total packets dropped, packet drop rate, error rate, etc.

Controller 200 can also include health scoring module 210 configured to calculate a health score for an end point group based on the operational data. The health score can indicate whether an actual performance of the end point group is meeting the desired performance of the end point group. The health score can be a numerical value that indicates the overall relative health of the end point group.

Health scoring module 210 can calculate the health score in any of a number of ways and based on any number of factors. In some embodiments, health scoring module 210 can calculate individual scores for multiple factors and calculate the health score based on the individual scores. For example, health scoring module 210 can add the individual scores together to calculate the health score. As another example, health scoring module 210 can determine the mean of the individual scores to calculate the health score for the EPG.

In some embodiments, health scoring module 210 can apply varying weights to the individual scores when calculating the health score. For example, individual scores for factors considered to be of greater importance can be assigned a higher weight and therefor have greater influence on the health score. Conversely, individual scores for factors considered to be of lower importance can be assigned a lower weight and have a lesser impact on the health score.

Health scoring module 210 can determine, based on the health score for an EPG, whether the actual performance of the EPG is meeting the desired performance of the EPG. For example, health scoring module 210 can compare the health score to a threshold health score to determine whether the health score meets or exceeds the threshold health score. Health scoring module 210 can determine that the actual performance of the EPG meets the desired performance of the EPG when the health score meets or exceeds the threshold health score. Conversely, health scoring module 210 can determine that the actual performance of the EPG is not meeting the desired performance of the EPG when the health score does not meet or exceed the threshold health score.

Controller 200 can further include policy management module 215 configured to modify policies applied to an EPG. For example, in response to a determination that the actual performance of an EPG does not meet the desired performance of the EPG, policy management module 215 can adjust the policies applied to the EPG. This can include increasing the service level assigned to the EPG and applying the set of policies associated with the increased service level to the EPG. Controller 200 can include policy storage 220 configured to store the details of the various service levels, including the sets of policies associated with each. Policy management module 215 can be configured to communicate with policy storage 220 to determine the set of policies associated with a service level and apply the set of policies to an EPG.

In addition to increasing the service level assigned to an EPG, in some embodiments, policy management module 215 can decrease the service level assigned to an EPG. For example, in response to a determination that the actual performance of an EPG is greatly exceeding the desired performance of the EPG, policy management module 215 can decrease the service level assigned to the EPG.

Controller 200 can continuously monitor the health of EPGs and adjust the policies assigned to the EPGs if needed. For example, after applying a new set of policies to an EPG, controller 200 can continue to gather additional operational data and calculate an updated health score for the EPG based on the additional operational data. The controller can then determine, based on the updated health score, whether the actual performance of the EPG is meeting the desired performance of the end point group. In response to determining that the actual performance of the EPG is not meeting the desired performance of the end point group, controller 200 can again increase the service level assigned to the EPG and apply the set of policies associated with the increased service level to the EPG. This process can be continued to achieve the desired performance of the EPG. Policies applied to the EPG are not adjusted when controller 200 determined that the actual performance of the EPG is meeting the desired performance of the EPG.

Referring back to FIG. 1, the private cloud 102 can include one or more physical servers 124 that each deploy a hypervisor 126 (also sometimes referred to as a virtual machine manager or a virtual machine monitor (VMM)). The hypervisor 126 may be computer software, firmware, or hardware that creates and runs one or more VMs, such as VMs 128 or cVMs 118. Although the cVMs 118 are not shown to be encapsulated by a hypervisor in this example, it will be appreciated that VMs may or may not be managed by a hypervisor. The hypervisor 126 can provide a respective operating system to one or more VMs. In some example embodiments, the hypervisor 126 may be a native or “bare metal” hypervisor that runs directly on hardware, but that may alternatively run under host software executing on hardware. The hypervisor 126 can be managed by the virtualization platform or hypervisor manager 122, such as vSphere® from VMware®, Inc. of Palo Alto, Calif., Hyper-V® from Microsoft® Corp. of Seattle, Wash., XenServer® from Citrix® Systems, Inc. of Santa Clara, Calif., or Red Hat® Enterprise Virtualization from Red Hat®, Inc. of Raleigh, N.C.

Each VM, including VMs 128 and cVMs 118, can host a private application. In some example embodiments, each public cloud VM 118 may be connected to the public cloud network gateway 112 via secure access tunnels, as discussed elsewhere herein. In some example embodiments, one or more cVMs 118 can be configured to operate as a public cloud firewall (not shown), such as an Intercloud Fabric™ Firewall or Virtual Security Gateway (VSG) from Cisco®. In some example embodiments, one or more cVMs 118 can be configured to operate as a public cloud router (not shown), such as an Intercloud Fabric™ Router or Cloud Services Router (CSR) from Cisco®.

In some example embodiments, the public cloud network gateway 112 can establish, from the public cloud 104, the secure site-to-site tunnel 108 to interconnect with the private cloud network gateway 110, secure access tunnels to connect public cloud VMs (cVMs) 118, and monitor and report statistics for the public cloud VMs and any component failures in the public cloud 104. In some example embodiments, the private cloud network gateway 110 and the public cloud network gateway 112 can be deployed as a high-availability pair to provide redundancy. In some example embodiments, the public cloud network gateway 112 can include a cloud virtual switch or cloud Virtual Ethernet Module (cVEM) 116b that communicates with the VSM 114 to retrieve VM-specific network policies (e.g., port profiles), switches network traffic between public cloud VMs 118, switches network traffic between public cloud VMs and the private cloud 102, applies network policies, and monitors and reports VEM-related statistics.

In some example embodiments, each physical server, such as physical server 124, hosting a VM, including VM 128 and cVM 118, can include multiple Virtual Network Interface Cards (VNICs) (not shown) for providing specific functionality, such as control and/or data/packet transmission. For example, a VM on a physical server can include a vNIC that may be connected to a VEM, such as VEM 116a or cVEM 116b, for connecting the VM or cVM to the network. Each physical server 124 can include a vNIC for enabling control functionality, such as Small Computer Systems Interface over IP (iSCSI), Network File System (NFS) access, migration of VMs or cVMs, directly connected tunnels, discussed elsewhere herein, as well as other control functionality.

In some example embodiments, each public cloud VM 118 can include an agent (not shown) that provides for the network overlay logic for the public cloud VM. The agent can be deployed in the cVM as a secure tunnel driver. The agent can establish a secure access tunnel to connect the public cloud VM 118 to the public cloud network gateway 112, and monitor and report secure overlay-related statistics. In an example embodiment, the agent can be implemented using Intercloud Fabric™ Agent (ICA) from Cisco®.

In some example embodiments, the secure site-to-site tunnel or communication link 108 can take one of several forms, such as various types of virtual private networks (VPNs) or Layer 2 (L2) tunneling protocols. For example, some example embodiments may utilize an open VPN (e.g., OpenVPN) overlay or an IP Security (IPSec) VPN based L3 network extension to provide the communication link 108. Some example embodiments may utilize a secure transport layer (i.e., L4) tunnel as the communication link 108 between the private cloud network gateway 110 and the public cloud network gateway 112, where the secure transport layer tunnel 108 can be configured to provide a link layer (i.e., L2) network extension between the private cloud 102 and the public cloud 104. Some example embodiments may establish the secure transport layer (i.e., L4) tunnel 108 (e.g., Transport Layer Security (TLS), Datagram TLS (DTLS), Secure Socket Layer (SSL), etc.) over the public network 104, and can build a secure L2 switch overlay that interconnects public cloud resources with private clouds (e.g., enterprise network backbones). In other words, the secure transport layer tunnel 108 can provide a link layer network extension between the private cloud 102 and the public cloud 104.

In an example embodiment, the private cloud network gateway 110 can use an L4 secure tunnel as the communication link 108 to connect to the cloud resources allocated in the public cloud 104. The L4 secure tunnel may be well-suited for use with corporate firewalls and Network Address Translation (NAT) devices due to the nature of the transport level protocols (e.g., UDP/TCP) and the transport layer ports opened for HTTP/HTTPS in the firewall. The L2 network can thus be further extended and connected to each of the cloud VMs 118 through the public cloud network gateway 112. With an L2 network overlay, instances of a particular private application VM can be seamlessly migrated to the overlay network dynamically created in the public cloud 104, without substantial impact to existing corporate infrastructure.

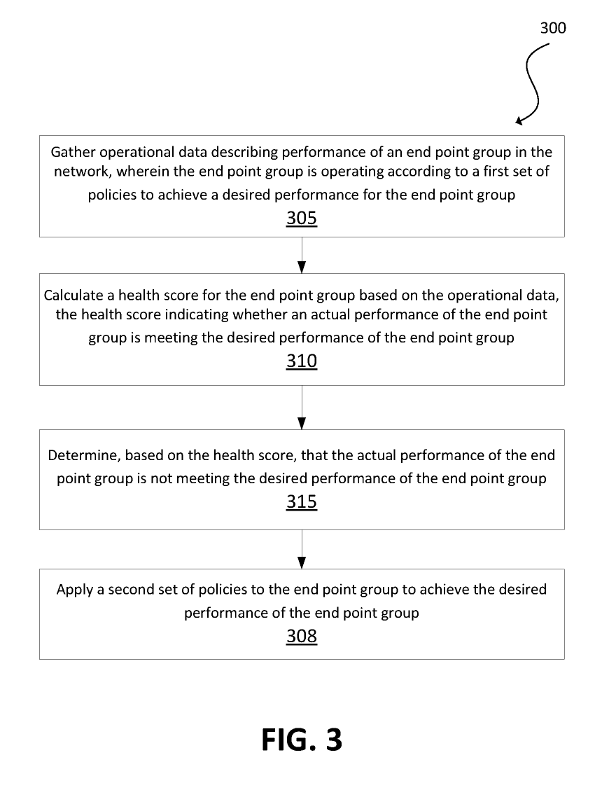

FIG. 3 shows an example method of monitoring performance of an EPG and adjusting policies to achieve a desired result. It should be understood that there can be additional, fewer, or alternative steps performed in similar or alternative orders, or in parallel, within the scope of the various embodiments unless otherwise stated.

At step 305, a controller in a network gathers operational data describing performance of an end point group in the network, wherein the end point group is operating according to a first set of policies to achieve a desired performance for the end point group. The operational data can include at least one of current load, errors, warnings, exceptions, bandwidth, throughput, delay, latency, jitter, total packets dropped, packet drop rate, error rate, central processing unit (CPU) rate, etc. The first set of policies can be associated with a current service level assigned to the EPG.

At step 310 the controller can calculate a health score for the end point group based on the operational data, the health score indicating whether an actual performance of the end point group is meeting the desired performance of the end point group.

At step 315 the controller can determine, based on the health score, that the actual performance of the end point group is not meeting the desired performance of the end point group. For example, to determine that the actual performance of the end point group is not meeting the desired performance of the end point group, the controller can compare the health score to a threshold health score, and determine that the health score does not meet or exceed the threshold health score.

At step 320 the controller can apply a second set of policies to the end point group to achieve the desired performance of the end point group. For example, the controller can assign the EPG to an increased service level that is associated with the second set of policies. The controller can then apply the second set of polices to the EPG.

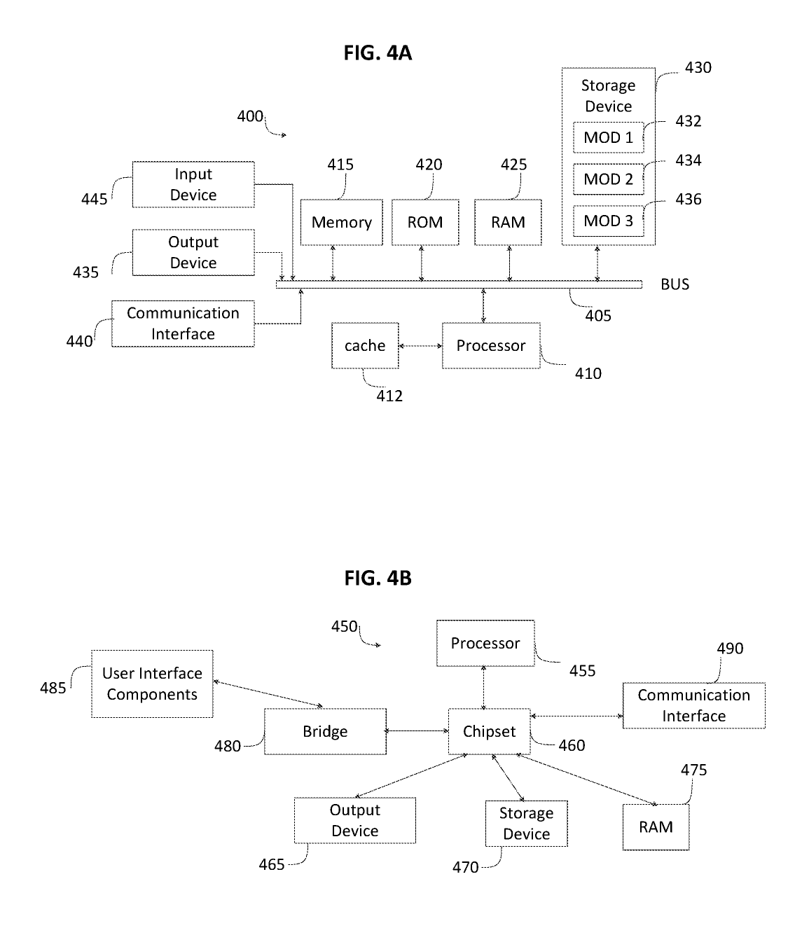

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 460 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 462, module 2 464, and module 6 466 stored in storage device 460, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 465 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 460 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 460 can include software modules 462, 464, 466 for controlling the processor 410. Other hardware or software modules are contemplated. The storage device 460 can be connected to the system bus 405. In one aspect, a hardware module that performs a particular function can include the software component stored in a computer-readable medium in connection with the necessary hardware components, such as the processor 410, bus 405, display 465, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

For clarity of explanation, in some instances the present technology may be presented as including individual functional blocks including functional blocks comprising devices, device components, steps or routines in a method embodied in software, or combinations of hardware and software.

Note that in certain example implementations, the optimization and/or placement functions outlined herein may be implemented by logic encoded in one or more tangible, non-transitory media (e.g., embedded logic provided in an application specific integrated circuit [ASIC], digital signal processor [DSP] instructions, software [potentially inclusive of object code and source code] to be executed by a processor, or other similar machine, etc.). The computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
gathering, by a controller in a network, operational data describing performance of an end point group in the network, wherein the end point group is operating according to a first set of policies to achieve a desired performance for the end point group;
calculating a health score for the end point group based on the operational data, the health score indicating whether an actual performance of the end point group is meeting the desired performance of the end point group;
determining, based on the health score, that the actual performance of the end point group is not meeting the desired performance of the end point group; and
applying a second set of policies to the end point group to achieve the desired performance of the end point group.

2. The method of claim 1, wherein the operational data includes at least one of current load, errors, warnings, exceptions, bandwidth, throughput, delay, latency, jitter, total packets dropped, packet drop rate, error rate and central processing unit (CPU) rate.

3. The method of claim 1, wherein determining that the actual performance of the end point group is not meeting the desired performance of the end point group comprises:
comparing the health score to a threshold health score; and
determining that the health score does not meet or exceed the threshold health score.

4. The method of claim 1, wherein the first set of policies is associated with a first service level and the second set of policies is associated with a second service level, the second service level being higher than the first service level.

5. The method of claim 1, further comprising:
after applying the second set of policies, gathering additional operational data and calculating an updated health score for the end point group based on the additional operational data; and
determining, based on the updated health score, whether the actual performance of the end point group is meeting the desired performance of the end point group.

6. The method of claim 5, further comprising:
in response to determining that the actual performance of the end point group is not meeting the desired performance of the end point group, applying a third set of policies to the end point group to achieve the desired performance of the end point group.

7. The method of claim 5, wherein policies applied to the end point group are not adjusted in response to determining that the actual performance of the end point group is meeting the desired performance of the end point group.

8. A controller in a network, comprising:
one or more computer processors; and
a memory storing instructions that, when executed by the one or more computer processors, cause the controller to:
gather operational data describing performance of an end point group in the network, wherein the end point group is operating according to a first set of policies to achieve a desired performance for the end point group;
calculate a health score for the end point group based on the operational data, the health score indicating whether an actual performance of the end point group is meeting the desired performance of the end point group;
determine, based on the health score, that the actual performance of the end point group is not meeting the desired performance of the end point group; and
apply a second set of policies to the end point group to achieve the desired performance of the end point group.

9. The controller of claim 8, wherein the operational data includes at least one of current load, errors, warnings, exceptions, bandwidth, throughput, delay, latency, jitter, total packets dropped, packet drop rate, error rate and central processing unit (CPU) rate.

10. The controller of claim 8, wherein determining that the actual performance of the end point group is not meeting the desired performance of the end point group comprises:
comparing the health score to a threshold health score; and
determining that the health score does not meet or exceed the threshold health score.

11. The controller of claim 8, wherein the first set of policies is associated with a first service level and the second set of policies is associated with a second service level, the second service level being higher than the first service level.

12. The controller of claim 8, wherein the instructions further cause the controller to:
after applying the second set of policies, gather additional operational data and calculating an updated health score for the end point group based on the additional operational data; and
determine, based on the updated health score, whether the actual performance of the end point group is meeting the desired performance of the end point group.

13. The controller of claim 12, wherein the instructions further cause the controller to:
in response to determining that the actual performance of the end point group is not meeting the desired performance of the end point group, apply a third set of policies to the end point group to achieve the desired performance of the end point group.

14. The controller of claim 12, wherein policies applied to the end point group are not adjusted in response to determining that the actual performance of the end point group is meeting the desired performance of the end point group.

15. A non-transitory computer-readable medium storing instructions that, when executed by a controller in a network, cause the controller to:
gather operational data describing performance of an end point group in the network, wherein the end point group is operating according to a first set of policies to achieve a desired performance for the end point group;
calculate a health score for the end point group based on the operational data, the health score indicating whether an actual performance of the end point group is meeting the desired performance of the end point group;
determine, based on the health score, that the actual performance of the end point group is not meeting the desired performance of the end point group; and
apply a second set of policies to the end point group to achieve the desired performance of the end point group.

16. The non-transitory computer-readable medium of claim 15, wherein the operational data includes at least one of current load, errors, warnings, exceptions, bandwidth, throughput, delay, latency, jitter, total packets dropped, packet drop rate, error rate and central processing unit (CPU) rate.

17. The non-transitory computer-readable medium of claim 15, wherein determining that the actual performance of the end point group is not meeting the desired performance of the end point group comprises:
comparing the health score to a threshold health score; and
determining that the health score does not meet or exceed the threshold health score.

18. The non-transitory computer-readable medium of claim 15, wherein the instructions further cause the controller to:
after applying the second set of policies, gathering additional operational data and calculate an updated health score for the end point group based on the additional operational data; and
determine, based on the updated health score, whether the actual performance of the end point group is meeting the desired performance of the end point group.

19. The non-transitory computer-readable medium of claim 18, wherein the instructions further cause the controller to:
in response to determining that the actual performance of the end point group is not meeting the desired performance of the end point group, apply a third set of policies to the end point group to achieve the desired performance of the end point group.

20. The non-transitory computer-readable medium of claim 18, wherein policies applied to the end point group are not adjusted in response to determining that the actual performance of the end point group is meeting the desired performance of the end point group.
